(19) United States
(12) Patent Application Publication
(10) Pub. No.: US 2012/0311958 A1
(43) Pub. Date: Dec. 13, 2012

(54) INSULATION ART

(76) Inventor: William August, Cambridge, MA (US)

(21) Appl. No.: 13/157,667

(22) Filed: Jun. 10, 2011

(51) Int. Cl. E04B 1/74; B32B 33/00

(52) U.S. Cl. 52/741.4; 428/195.1

(57) ABSTRACT

A manufacture for insulating a wall, said manufacture includes: an insulation board, and visual artwork on a surface of said insulation board.

### FIELD OF DISCLOSURE

This disclosure relates to art and energy conservation and carbon fuel reduction, and in particular, to wall insulation.

### BACKGROUND

A tremendous amount of carbon fuel-generated heat and energy are lost through the exterior walls of homes and other buildings. The primary response to this has been to insulate inside of the exterior walls, with either blow-in insulation or fiberglass stapled between the wall studs or roof rafters inside of the wall or ceiling. However, many home and building owners have been unable to afford or implement the placement of insulation inside their exterior walls, which often requires time-consuming and messy (and sometimes even toxic) opening, gutting and re-sealing of walls. An alternative response to exterior wall heat loss has been to place a layer of insulation on the room-facing, exposed interior surface of the exterior wall (without having to get inside the wall itself). However, a layer of insulation on the room-facing, exposed interior surface of the exterior wall of a home or office is unsightly, undesirable, and rarely done because of the aesthetic barrier to placement of insulation on the room-facing interior wall surfaces of the room. In addition, many tenants and non-owners may lack the authority, permission or means to open walls to install insulation inside of their walls.

### SUMMARY

A need therefore exists for new and supplemental insulation products for the room-facing, exposed interior surface of the exterior wall to overcome the aesthetic barriers to such use. A combination of art and insulation into pre-fabricated “insulation art” overcomes the aesthetic barriers to placement of insulation on the exposed interior surface of the exterior walls. The insulation industry has not previously created insulation art, and the invention's combination of insulation and art provides great utility to home and building owners, enabling them to overcome the aesthetic barriers to use of insulation on the interior walls of home and office; and thus creates great utility by simultaneously insulating and providing art for the home and other buildings.

In one aspect, the invention features a manufacture for insulating a wall. Such a manufacture includes an insulation board, and visual artwork on a surface of the insulation board.

In some embodiments, the manufacture also includes means for affixing the artwork to the board. Exemplary means for achieving this function include one or more of an adhesive, tape, clasps, staples, pins or nails.

In some embodiments, the artwork is superimposed onto a substrate, and the substrate is attached to and at least partially covers the insulation board. Among these embodiments are those in which the substrate is attached to the insulation board with an adhesive, those in which the artwork is printed onto the substrate, those in which the substrate includes a fabric, and those in which the substrate includes a sheet. One example of a suitable sheet is a vinyl sheet. Another example of a substrate is one made of polyester such as an adhesive polyester fabric. A suitable polyester fabric is one sold under the name PHOTOTEX™.

In some embodiments, the artwork is wrapped around and taped to the insulation board. But in others, the artwork is integral with the insulation board.

Among the embodiments of the manufacture are those in which the insulation board includes a thermal insulator and those in which the insulation board is fire-retardant.

Yet other embodiments include those in which the insulation board includes an insulating panel.

In another aspect, the invention features a method for insulating a wall facing an interior space. Such a method includes creating an insulation board with artwork affixed to the board.

In most practices, the method includes affixing the insulation board against a wall, whereby the insulation board and the artwork thereon are visible from the interior space. Among these are practices in which affixing the insulation board against a wall includes thermally insulating the wall.

Yet other practices include integrating the artwork with the insulation panel.

In additional practices of the invention, creating an insulation board includes placing artwork on a polyester fabric and affixing that fabric to the insulation board.

In other practices of the invention, creating an insulation board includes placing artwork on vinyl and affixing that vinyl to the insulation board.

Yet other practices of the invention are those in which creating an insulation board includes placing artwork on a sheet and affixing that sheet to the insulation board.

Practices of the invention include those in which creating an insulation board with artwork includes affixing the artwork with at least one of an adhesive, tape, clasps, staples, pins and nails.

An invention as described herein combines artwork onto room-facing, interior wall surface insulation, giving insulation a level of acceptability, removal of aesthetic barriers and utility it previously did not have

The invention as described herein gives artists a whole new medium and market to display art and to use the display of art to simultaneously provide the environmental benefits that are derived from insulation, thus enabling artists to pioneer new art forms that seek to combine art and the use of an environmentally helpful materials.

These and other features of the invention will be apparent from the following detailed description and the accompanying figure, in which:

### DESCRIPTION OF THE DRAWINGS

FIG. 1 shows an installation of artwork on insulation.

### DETAILED DESCRIPTION

Insulation board has historically primarily been installed between the exterior and interior surfaces of an exterior wall. The alternative of placing insulation board on an interior, room-facing, exposed surface of an interior wall is rarely utilized in regular living quarters including but not limited to living rooms, dining rooms and offices, because it creates an unsightly application of building materials in a home or office.

A solution to the foregoing problem is the pre-fabrication of visual art forms onto insulation board to create a new insulation art product. For example, one can install an interior facing insulation art product on a room-facing, interior surface of a building's exterior wall. This serves two functions, namely that of insulating the interior space while simultaneously providing an aesthetically pleasing interior.

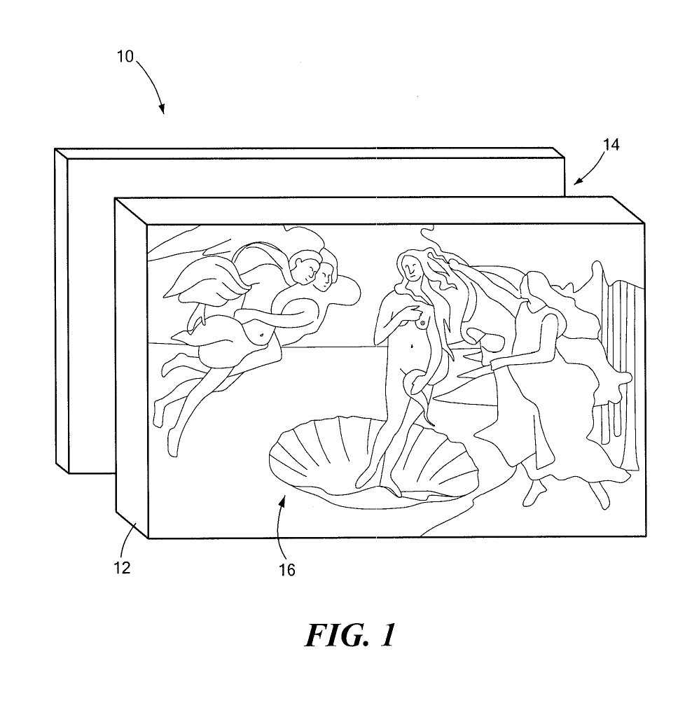

Referring to FIG. 1, a cross section of typical installation includes an exterior wall 10 with an insulating board 12 adjacent thereto. Insulation art 16 is artwork affixed directly on a surface of the insulating board 12. The art 16 can be affixed using a variety of ways, such as by adhesives or by wire nails. In some cases, the art 16 can be imprinted directly on the insulating board 12 or on a fabric, sheet or foil covering the insulating board 12.

In cases where the inside of an exterior wall is already insulated, the insulation art product supplements the existing insulation by providing an additional layer of insulation, which is placed on the inside surface (i.e. the surface visible from inside the room) of the exterior wall.

During installation, it is preferable to affix the insulation board tightly and firmly against a wall, thus maximizing its insulation effect by leaving negligible air space between it and the wall. The result of this installation is thermally insulating the wall, saving energy and reducing energy costs, all while providing artwork.

As used herein, “insulation art” includes the combination of insulation board with a visual art form, including but not limited to: photographs, fabrics, prints, posters, paintings, whether superimposed photographically or digitally on a fabric, a sheet of paper or cardboard, or other stock, or any other substrate for the artwork. The visual art form that would be displayed on a room-facing surface of the insulating board 12 could include ink, paints, dyes, colors, drawings, photographs, pictures, posters, engravings; holograms; relief works; and other visual art forms, all of which can be affixed to or integrated onto the insulating board 12.

In some embodiments, insulation art is an insulating replacement for wallpaper that carries out both the decorative function of wallpaper, while simultaneously insulating the room. Insulation art is also easier to install and remove than traditional wallpaper.

In some embodiments, insulation art can include a decorative texture applied to the insulating board 12.

As is well known in the art, an R value is a measure of an extent to which building insulation material is expected to insulate. Typical insulation boards are on the order of 1-3 inches thick and have R values in excess of 5. However, as is well known, the thickness required to achieve a particular level of insulation can depend on the materials used and the configuration and installation of those materials.

Having described the invention, and a preferred embodiment thereof, what I claim as new and secured by Letters Patent is:

1. A manufacture for insulating a wall, said manufacture comprising:
an insulation board, and
visual artwork on a surface of said insulation board.

2. The manufacture of claim 1, further comprising means for affixing the artwork to the board.

3. The manufacture of claim 1, wherein the artwork is superimposed onto a substrate, and wherein said substrate is attached to and at least partially covers the insulation board.

4. The manufacture of claim 3, wherein the substrate is attached to the insulation board with an adhesive.

5. The manufacture of claim 3, wherein the artwork is printed onto the substrate.

6. The manufacture of claim 3, wherein the substrate comprises a fabric.

7. The manufacture of claim 3, wherein the substrate comprises a sheet.

8. The manufacture of claim 7, wherein the sheet comprises a vinyl sheet.

9. The manufacture of claim 3, wherein the substrate comprises polyester.

10. The manufacture of claim 1, wherein the artwork is wrapped around and taped to the insulation board.

11. The manufacture of claim 1, wherein the artwork is integral with the insulation board.

12. The manufacture of claim 1, wherein the insulation board comprises a thermal insulator.

13. The manufacture of claim 1, wherein the insulation board comprises an insulating panel.

14. The manufacture of claim 1, wherein the insulation board is fire-retardant.

15. A method for insulating a wall facing an interior space, said method comprising creating an insulation board with artwork affixed to the board.

16. The method of claim 15, wherein creating an insulation board with artwork comprises placing the artwork on a polyester fabric, and affixing the polyester fabric to the board.

17. The method of claim 15, wherein creating an insulation board with artwork comprises placing the artwork on vinyl, and affixing the vinyl to the board.

18. The method of claim 15, wherein creating an insulation board with artwork comprises placing the artwork on a sheet, and affixing the sheet to the board.

19. The method of claim 15, wherein creating an insulation board with artwork comprises placing the artwork on a fabric, and affixing the fabric to the board.

20. The method of claim 15, wherein creating an insulation board with artwork comprises affixing said artwork with adhesive.
